(19) United States
(12) Patent Application Publication
(10) Pub. No.: US 2025/0186287 A1
(43) Pub. Date: Jun. 12, 2025

(54) PROGRAMMABLE MULTI-THERAPY INVERSION TABLE

(71) Applicant: Marcus Curry, San Diego, CA (US)

(72) Inventor: Marcus Curry, San Diego, CA (US)

(21) Appl. No.: 19/056,451

(22) Filed: Feb. 18, 2025

Related U.S. Application Data
(63) Continuation-in-part of application No. 18/419,507, filed on Jan. 22, 2024, now Pat. No. 12,226,358.
Application No. 18/419,507 is a continuation of application No. 17/179,300, filed on Feb. 18, 2021, now Pat. No. 11,877,972.

(51) Int. Cl. A61H 1/02; A61G 13/00; A61G 13/08; A61G 13/12; A61H 23/00

(52) U.S. Cl. CPC A61H 1/0229; A61G 13/009; A61G 13/08; A61G 13/121; A61H 1/0237; A61H 1/0296; A61H 23/00; A61G 2203/10; A61G 2210/90; A61H 2201/0207; A61H 2201/1611; A61H 2201/1623; A61H 2201/1642; A61H 2201/1669; A61H 2201/5002; A61H 2201/5007; A61H 2203/0456; A61H 2205/086

(57) ABSTRACT

An inversion table that incorporates additional therapies, such as massage, traction, and heat. Therapeutic elements of the inversion table may be programmable, so that settings are cycled automatically through preprogrammed patterns. Illustrative programs may include: (1) dynamic inversion that gradually increases the range of negative (inverted) and positive (upright) tilt angles; (2) dynamic massage that successively activates massage elements for different body parts in conjunction with changes in tilt angles; (3) dynamic traction, that gradually increases traction tension in conjunction with increased range of inversion angles; (4) dynamic heating and traction, that gradually increases heating pad temperature in conjunction with cycling traction tension; and (5) dynamic infrared heating and inversion, that gradually increases infrared heating temperature in conjunction with increasing the amount of inversion.

This patent application is a continuation-in-part of U.S. Utility patent application Ser. No. 18/419,507, filed 22 Jan. 2024, which is a continuation of U.S. Utility patent application Ser. No. 17/179,300, filed 18 Feb. 2021, the specifications of which are hereby incorporated herein by reference.

### BACKGROUND OF THE INVENTION

### Field of the Invention

One or more embodiments of the invention are related to the field of physical therapy devices. More particularly, but not by way of limitation, one or more embodiments of the invention enable a programmable multi-therapy inversion table.

### Description of the Related Art

Inversion tables for spinal decompression are known in the art. Generally these tables are simple mechanical devices that a user manually rotates to position the head lower than the legs in order to stretch the spine. While these devices can be effective, some patients benefit from other kinds of therapies such as traction, massage, or heat. Some devices have added heating pads to inversion tables, but full integration of a wider range of therapies into a single inversion table has not been performed.

An additional limitation of most existing inversion tables is that they are either manually positioned by the user, or if they support electronic control then the user must enter specific settings (for example for the tilt angle of the table). In some situations, users may benefit from time-varying settings that are cycled automatically, which could be accomplished with a programmable inversion table.

For at least the limitations described above there is a need for a programmable multi-therapy inversion table.

### BRIEF SUMMARY OF THE INVENTION

One or more embodiments described in the specification are related to a programmable multi-therapy inversion table. Embodiments of the invention may incorporate multiple therapeutic elements into an inversion table and may programmatically control the settings of these elements to execute sequences of therapies.

One or more embodiments of the invention may include a supporting frame, a back rest, and one or more moving back massage elements coupled to the back rest. The back rest may be coupled to the frame so that it can rotate between an upright position with the superior end (closest to the head) vertically higher than the inferior end (closest to the feet), and an inverted position with the superior end vertically lower than the inferior end. The one or more moving back massage elements may each have a back vibrating element that applies vibration to the user's back, and a back massage element position actuator that moves the vibrating element along a track in or coupled to the back rest, in order to position the vibrating element at multiple locations of the user's back.

One or more embodiments of the invention may also have a table tilt actuator that moves the back rest between its upright and inverted positions.

In one or more embodiments, the track along which a back massage element moves may be a slot in the back rest; it may for example extend from a first position closest to the superior end of the back rest to a second position closest to the inferior end.

One or more embodiments may have two moving back massage elements that move in parallel tracks.

In one or more embodiments, each moving back massage element may also be configured to rotate the back vibrating element.

One or more embodiments may include a head and neck support coupled to the back rest. It may include a neck traction actuator that moves the head and neck support away from the back rest.

In one or more embodiments, one or more moving neck massage elements may be coupled to the head and neck support. Each neck massage element may have a neck vibrating element that applies vibration to the user's neck, and a neck massage position actuator that moves the vibrating element along a track in or coupled to the head and neck support, in order to position the vibrating element at multiple locations of the user's neck.

In one or more embodiments, the track associated with a moving neck massage element may be a slot in the head and neck support. The track may extend from a first position closest to the superior end of the head and neck support to a second position closest to the inferior end.

One or more embodiments may have two moving neck massage elements that may move in parallel tracks.

In one or more embodiments, the moving neck massage elements may be further configured to rotate the neck vibrating elements.

One or more embodiments may include a leg support coupled to the back rest. It may include a leg traction actuator that moves the leg support away from the back rest.

One or more embodiments may include a heating pad coupled to the back rest.

One or more embodiments may include a processor that is configured to set or modify one or more of the settings of any of the elements of the inversion table, such as the back rest, the table tilt actuator, the moving back massage element or elements, the moving neck massage element or elements, the neck traction actuator, the leg traction actuator, or the heating pad or pads. One or more embodiments may include a stored program that executes on the processor and that sets or modifies one or more of these settings.

One or more embodiments of a programmable multi-therapy inversion table may include a supporting frame, a back rest, a leg and feet support coupled to the back rest, and a head and neck support coupled to the back rest. The back rest may be rotatably coupled to the supporting frame. It may have a superior end closest to the user's head, and an inferior end closest to the user's feet. It may be configured to rotate between an upright position wherein the superior end is vertically higher than the inferior end, and an inverted position wherein the superior end is vertically lower than the inferior end. The table may include multiple therapy actuators. These actuators may include: a table tilt actuator configured to rotate the back rest between the upright and inverted positions; multiple massage elements, each independently actuated, including a feet massage element, a calves massage element, a hamstrings massage element, a gluteal muscles massage element, a back massage element, and a neck massage element; multiple traction elements, each independently actuated, including a thoracic traction element and a lumbar traction element; multiple heating pads, each independently actuated, including a feet heating pad, a calves heating pad, a hamstrings heating pad, a gluteal muscles heating pad, and a back heating pad; and one or more infrared heating panels oriented to direct heat at the user's body. The table may include a processor coupled to the therapy actuators, and a memory coupled to the processor that contains one or more programs. Each program may be configured to modify the settings of one or more of the therapy actuators over time in a predefined sequence.

In one or more embodiments, a first program may be configured to modify the tilt angle of the table tilt actuator through a sequence of angle ranges. Each angle range of the sequence of angle ranges may have a lower limit and an upper limit. The lower limit of each angle range may be lower than the lower limit of the previous angle range in the sequence of angle ranges, and the upper limit of each angle range may be higher than the upper limit of the previous angle range in the sequence of angle ranges. In one or more embodiments, the sequence of angle ranges may include: a first angle range from −3 degrees to +0 degrees, a second angle range from −5 degrees to +1 degrees, a third angle range from −7 degrees to +3 degrees, a fourth angle range from −9 degrees to +5 degrees, a fifth angle range from −11 degrees to +7 degrees, and a sixth angle range from −13 degrees to 0 degrees.

In one or more embodiments, a second program may be configured to modify the tilt angle of the table tilt actuator through a sequence of angles and to activate a massage element at each angle of the sequence of angles. In one or more embodiments this program may: set the tilt angle to 0 degrees and activate the feet massage element, set the tilt angle to −5 degrees and activate the calves massage element, set the tilt angle to −10 degrees and activate the hamstrings massage element, set the tilt angle to −15 degrees and activate the gluteal muscles massage element, set the tilt angle to −20 degrees and activate the back massage element, and set the tilt angle to −25 degrees and activate the neck massage element. The program may then perform this sequence of steps in the reverse order.

In one or more embodiments, a third program may be configured to modify the tilt angle of the table tilt actuator through a sequence of angle ranges and set the tension of the thoracic traction element and of the lumbar traction element in opposite directions and equal magnitudes at each angle range of the sequence of angle ranges. The lower limit of each angle range may be lower than the lower limit of the previous angle range in the sequence of angle ranges, and the upper limit of each angle range may be higher than the upper limit of the previous angle range in the sequence of angle ranges. The tension may increase at each subsequent angle range of the sequence of angle ranges. In one or more embodiments, this program may: move the tilt angle from −3 degrees to +3 degrees, with the tension set to 2 Newtons, then move the tilt angle from −5 degrees to +5 degrees, with the tension set to 4 Newtons, then move the tilt angle from −7 degrees to +7 degrees, with the tension set to 6 Newtons, then move the tilt angle from −9 degrees to +9 degrees. with the tension set to 8 Newtons, then move the tilt angle from −11 degrees to +11 degrees, with the tension set to 10 Newtons. In one or more embodiments, each angle range of the sequence of angle ranges may be performed twice before moving to the subsequent angle range.

In one or more embodiments, a fourth program may be configured to set the temperature of one or more of the heating pads through a sequence of temperatures for a corresponding sequence of durations, where the temperature increases through the sequence of temperatures and duration decreases through the corresponding sequence of durations. In one or more embodiments, this program may set the heating pad temperatures to 75 degrees F. for 120 seconds, then to 80 degrees F. for 90 seconds, then to 85 degrees F. for 60 seconds, then to 90 degrees F. for 45 seconds, and then to 95 degrees F. for 30 seconds. The program may vary the tension of the thoracic traction element and of the lumbar traction element from 0 Newtons to 5 Newtons at each temperature of the sequence of temperatures.

In one or more embodiments, a fifth program may be configured to set the temperature of one or more infrared heating panels through a sequence of temperatures for a corresponding sequence of durations, and to set the tilt angle of the table tilt actuator through a corresponding sequence of angles. The temperature may increase through the sequence of temperatures; the duration may decrease through the corresponding sequence of durations; and the tilt angle may decrease through the corresponding sequence of angles. In one or more embodiments, this program may set the temperature to 75 degrees F. for 2.5 minutes at −5 degrees tilt, then to 80 degrees F. for 2 minutes at −10 degrees tilt, then to 85 degrees F. for 1.5 minutes at −15 degrees tilt, then to 90 degrees F. for 1 minute at −20 degrees tilt, and then to 95 degrees F. for 0.5 minutes at −25 degrees tilt.

One or more embodiments of a multi-therapy inversion table may also include a control device configured to receive commands to change settings of one or more of the therapy actuators, and to transmit these commands to the processor. In one or more embodiments, the control device may be further configured to receive the commands via audio.

### BRIEF DESCRIPTION OF THE DRAWINGS

The above and other aspects, features and advantages of the invention will be more apparent from the following more particular description thereof, presented in conjunction with the following drawings wherein:

FIG. 1 shows an illustrative embodiment of an inversion table that incorporates additional therapies such as back and neck massage, neck and leg traction, and heat.

FIG. 2 shows a closeup view of the neck massage elements of the embodiment of FIG. 1.

FIG. 2A shows a variation of the inversion table of FIG. 1 that has additional gluteal and hamstring vibrating massage elements. FIG. 2B shows a variation of the inversion table of FIG. 1 that has additional calf vibrating massage elements.

FIGS. 3A and 3B show the embodiment of FIG. 1 in the upright and inverted positions, respectively.

FIG. 4 shows illustrative actuation degrees of freedom for the therapies provided by the embodiment of FIG. 1.

FIG. 5 shows a bottom view of the embodiment of FIG. 1, illustrating a belt drive mechanism that actuates the back massage elements, and a motor that drives the table tilt angle.

FIG. 6 shows settings output by an illustrative program that automatically controls the therapy elements incorporated into the embodiment of FIG. 1.

FIG. 7 shows a block diagram of illustrative components of an embodiment of a multi-therapy inversion table; these components may include for example actuators for tilt, heat, massage, and traction.

FIGS. 8 through 12 show five illustrative sequences of actuator settings that may be generated by stored programs that control the operation of the illustrative multi-therapy inversion table of FIG. 7.

FIG. 8 illustrates a program that gradually increases the tilt range of the table through a sequence of ranges.

FIG. 9 illustrates a program that decreases the table tilt (i.e., more inversion), and that activates different massage actuators at each successive tilt angle.

FIG. 10 illustrates a program that increases the tilt range of the table and increases the tension of traction elements as the tilt range increases.

FIG. 11 illustrates a program that increases the temperature of heating pads for successively smaller time periods, and that cycles traction tension at each temperature.

FIG. 12 illustrates a program that increases the temperature of infrared panels for successively smaller time periods, and that decreases the tilt angle (i.e., more inversion) at each successive temperature.

### DETAILED DESCRIPTION OF THE INVENTION

A programmable multi-therapy inversion table will now be described. In the following exemplary description, numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

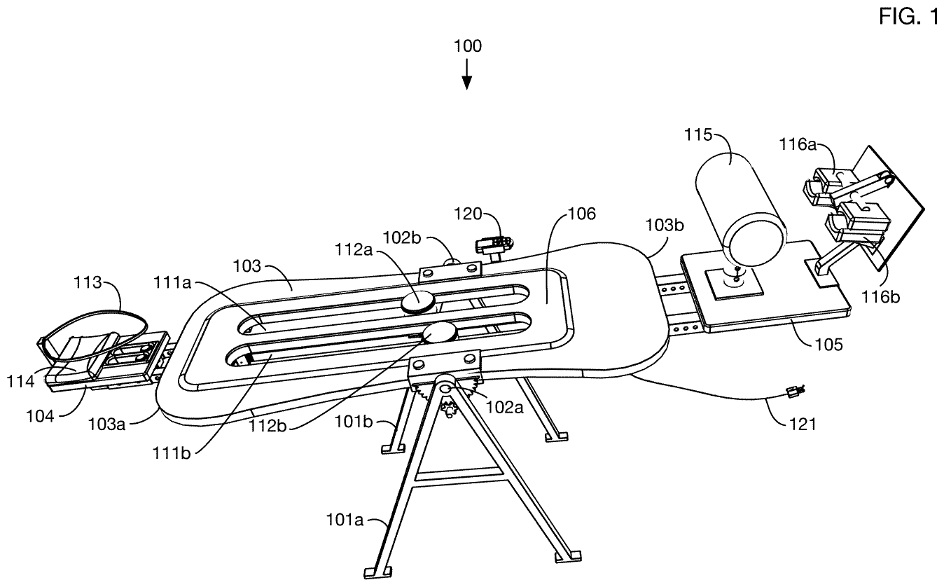

FIG. 1 shows an illustrative embodiment of the invention, viewed from above. This embodiment is an inversion table that incorporates additional therapeutic elements, such as for example, without limitation, any or all of massage, traction, and heat. The illustrative inversion table 100 has a support frame that includes two A-frames 101a and 101b, and a back rest 103 that is coupled to the frame at pivots 102a and 102b. Back rest 103 has a superior end 103a, which is toward the head of a user who lies on the back rest, and an inferior end 103b, which is toward the legs of the user. The pivots allow the inversion table to rotate so that a user may for example start with the legs below the head (so that superior end 103a is vertically higher than inferior end 103b), and then invert the table so that the head is lower than the legs (with superior end 103a lower than inferior end 103b). Inversion table 100 also has one or more back massage elements that are integrated into or coupled to the back rest 103. The embodiment shown in FIG. 1 has two back massage elements 112a and 112b. One or more embodiments may have any number of back massage elements. In illustrative inversion table 100, the massage elements 112a and 112b travel along tracks 111a and 111b, respectively, to provide massage to different portions of a user's back at different times. In this embodiment, the tracks are parallel and run along the axis from the superior end 103a to the inferior end 103b. This orientation and arrangement of the tracks is illustrative; in one or more embodiments the track or tracks along which a back massage element moves may be in any locations and orientations, and of any lengths and shapes. Tracks 111a and 111b include slots in back rest 103 into which the elements 112a and 112b fit. In one or more embodiments, the back rest may not have slots; instead, for example, the tracks for massage elements may be added to a solid back rest. Back massage elements 112a and 112b may for example have vibrating elements that vibrate or press against the user's back, or they may move in any manner or manners to provide any type of massage. For example, without limitation, elements 112a and 112b may vibrate, twist, pulse, inflate and deflate, press and release; they may move up and down, sideways, toward or away from the user's back, or in any direction or directions. In one or more embodiments, massaging elements 112a and 112b may move in multiple modes; for example they may vibrate, twist, and move along tracks 111a and 111b.

Illustrative inversion table 100 has a head and neck support 104 attached to the superior end 103a of back rest 103, and a leg support 105 attached to the inferior end 103b of back rest 103. Head and neck support 104 has a head rest 114 and a chin strap or other head support or brace 113; and leg support 105 has a knee pad 115 and ankle clamps or other foot braces or supports 116a and 116b. These supports may also incorporate additional therapies in one or more embodiments. For example, the supports may be coupled to the back rest via actuators that apply traction. Traction actuators may be located on the back rest or on the head and neck or leg supports. Force may be applied for example to head and neck support 104 to push it in the superior direction, thereby applying traction to the user's neck as chin strap 113 pulls the head away from the back. In one or more embodiments, chin strap 113 may be any brace, strap, or pad that can contact a portion of the user's head to apply a neck traction force. Force may be applied for example to leg support 105 to push it in the inferior direction, thereby applying traction to the user's legs or lower back as ankle clamps 116a and 116b or similar braces pull the feet away from the back. In one or more embodiments, traction may be applied to any body part in any direction. For example, an illustrative embodiment of the invention may provide five different traction axes: (1) shoulder traction (applying for example tension in the superior direction), (2) thoracic traction (applying for example tension in the superior direction), (3) neck/cervical traction (applying for example tension in the superior direction), (4) a second shoulder traction direction (applying for example tension in the inferior direction), and (5) lower back/lumbar traction (applying for example tension in the inferior direction).

One or more embodiments may incorporate one or more heating pads or other temperature control elements into any part of the inversion table. For example, inversion table 100 may have a heating pad 106 that covers all or a portion of back rest 103. Heating pads may also be incorporated for example into either or both of the head and neck support 104 and the leg support 105. In one or more embodiments, one or more vibrating elements may also provide heat. The temperature or heat output of any of the heating elements may be controllable. In one or more embodiments, heat may be applied to any body part or parts. For example, an illustrative embodiment of the invention may provide six heating pads, that heat respectively feet, calves, hamstrings, gluteal muscles, back, and neck; these pads may have controllable temperatures that can be set by the user or by a practitioner.

In addition to or instead of heating pads, one or more embodiments of the invention may include one or more infrared light sources. For example, there may be infrared panels mounted on each side of the machine's cradle, attached approximately 8 to 12 inches away, covering the user's body from head to feet while lying down in a supine position. One or more embodiments may have an infrared light wand that is tethered by a cable from an infrared source box that may be attached to the machine; this wand may be applied by a practitioner to treat a person while lying on the machine, for example.

Inversion table 100 may for example be powered via an electrical connection 121, or via a battery. It may include one or more user control devices such as device 120, which may for example allow the user to modify the settings of any of the therapy elements of the inversion table.

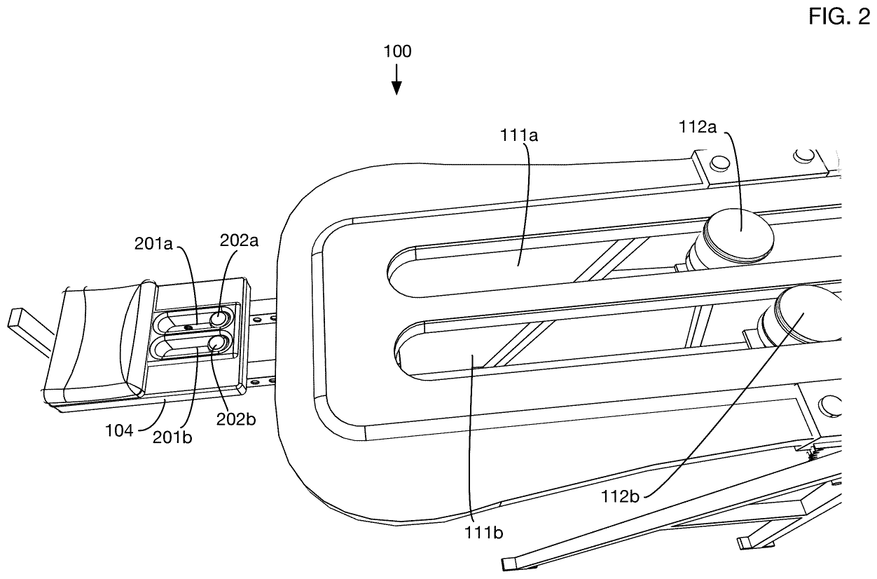

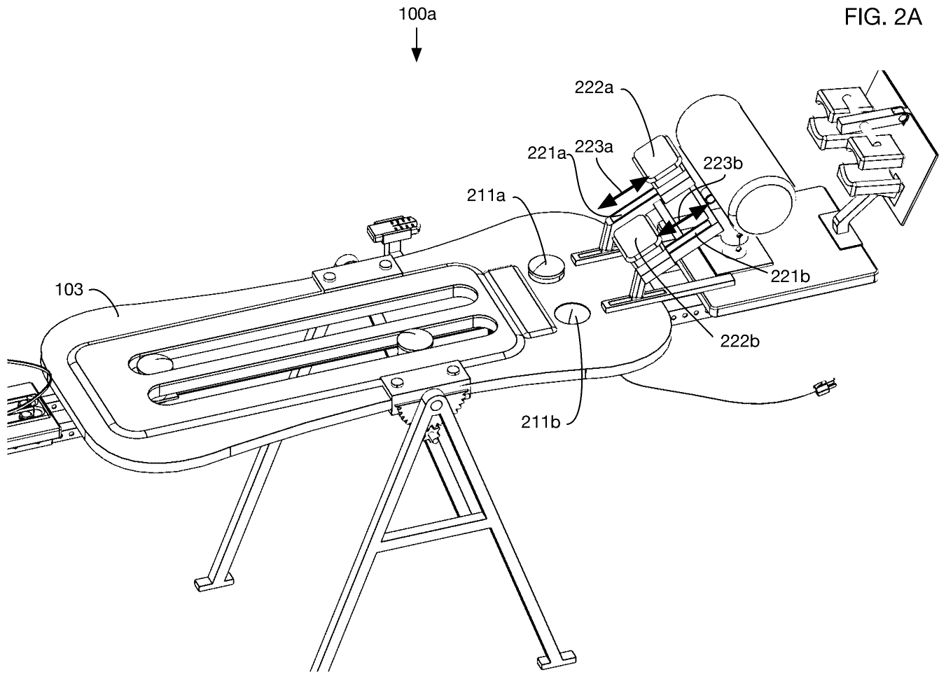

In one or more embodiments, head and neck support 104 may incorporate one or more massage elements to massage for example the neck or the back of the head. FIG. 2 shows a closeup view of the head and neck support element 104 of the inversion table 100 to show illustrative neck massage elements. In this embodiment, these neck massage elements are similar to the back massage elements 112a and 112b, but they are smaller in order to focus on the smaller area of the neck. For example, massage elements 202a and 202b may travel in tracks 201a and 201b, respectively, so that different portions of the neck may be massaged. One or more embodiments may use any number of neck massage elements, and the track or tracks may have any positions, orientations, lengths, or shapes. In the embodiment shown in FIG. 2, the tracks 201a and 201b run from along the superior-to-inferior axis, like the tracks 111a and 111b for the back massage elements. Tracks 201a and 201b may be for example slots in the neck support into which the neck massage elements fit. Like the back massage elements, the neck massage elements may vibrate, twist, pulse, inflate and deflate, press and release, move up and down, sideways, toward or away from the user's neck, or in any direction or directions. In one or more embodiments, massaging elements 202a and 202b may move in multiple modes; for example they may vibrate, twist, and move along tracks 201a and 201b.

The components of the inversion table may be constructed of any desired materials. For example, the back rest may be made of polyurethane.

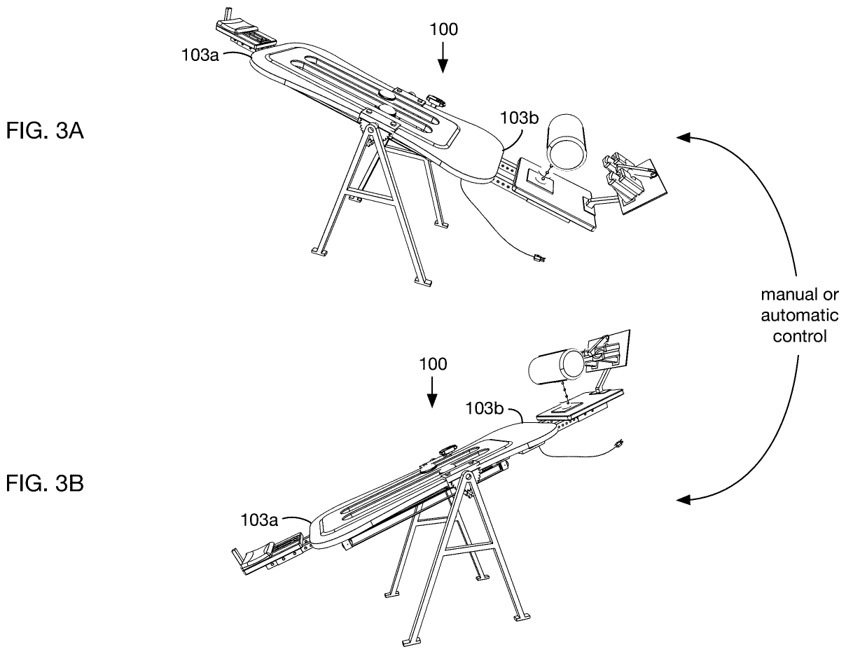

One or more embodiments may incorporate leg massage elements into the leg support 105. More generally, embodiments may incorporate any number of massage elements positioned at any location in the inversion table, to target any desired portion or portions of the user's body. These massage elements may be stationary, or they may move. For example, FIG. 2A shows an illustrative inversion table 100a with left and right gluteal massage elements 211a and 211b, respectively, integrated into the inferior end of the back rest 103. This embodiment also has left and right hamstring massage elements 222a and 222b, which may move in tracks 221a and 221b, respectively to massage different portions of the user's hamstrings. For example, left hamstring massage element 222a may move up and down in directions 223a along track 221a, and right hamstring massage element 222b may move up and down in directions 223b along track 221b. Like the other massage elements of table 100, any or all of these massage elements 211a, 211b, 222a, and 222b may vibrate, twist, pulse, inflate and deflate, press and release, move up and down, sideways, toward or away from any part of the user's body, or in any direction or directions. These massage elements, and all others, may also provide heating, cooling, or any other desired therapy. In addition, all massage elements may pitch or roll or yaw. Pitch relates to the axis orthogonal to the spine of the user, roll relates to the axis parallel to the spine and yaw relates to the axis orthogonal to the plane that defines the pitch and roll axes. For example. based on the differing anatomy of the gluteal muscles and angle that the muscles approach the lower back, percussion elements 211a and 211b may be manually or programmatically adjusted in pitch about an axis orthogonal to the spine, (parallel to tilt angle 401 as shown in FIG. 4). In one or more embodiments, all massage elements including 211a and 211b be adjusted in pitch or roll or yaw before treatment or during treatment, i.e., be statically adjusted or dynamically adjusted over time in pitch or roll or yaw. In addition, the hamstring assembly can be added on the other side of knee rest 115 and between knee rest 115 and foot braces or supports 116a and 116b to provide percussion to the calves as shown in FIG. 2B. Such an arrangement allows for both the hamstrings and calves to be engaged in an embodiment equipped with two such arrangements. In one or more embodiments, the massage elements on the calf side may be made the same size, or smaller, e.g., 20% smaller for calf percussion as added to the other side of knee rest 115 with appropriate bracing.

One or more embodiments may include any number of massage elements that target any body part or parts. For example, an illustrative embodiment may include massage elements that target six different body areas: feet, calves, hamstrings, gluteal muscles, back, and neck.

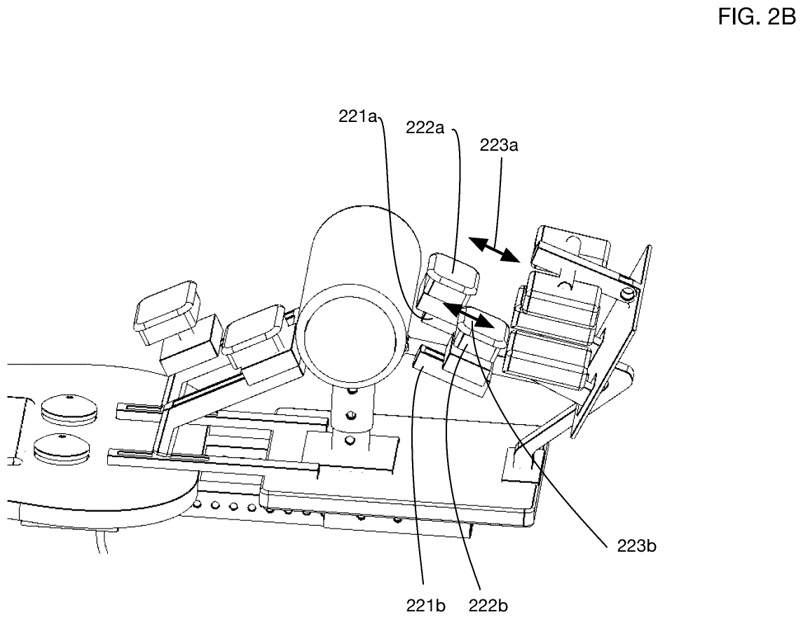

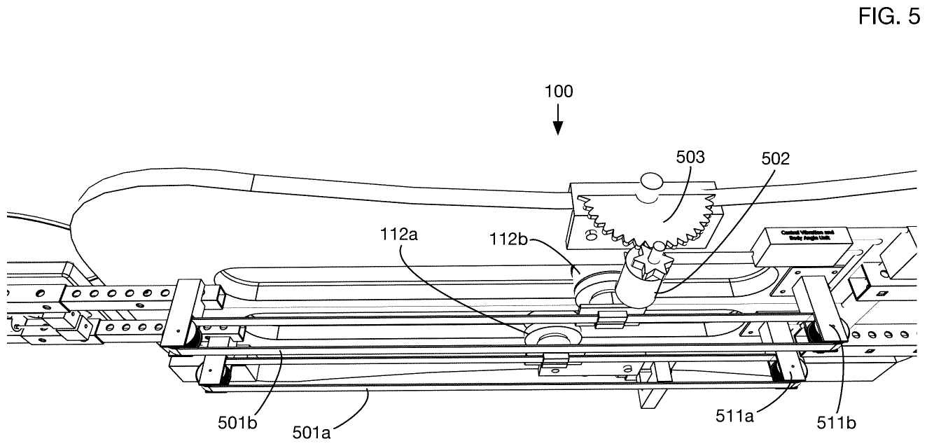

FIGS. 3A and 3B show upright and inverted positions, respectively, of the inversion table. In the upright position, the superior end 103a of the back rest is vertically higher than the inferior end 103b; this is reversed in the inverted position. In one or more embodiments the user may manually command the inversion table to move from the upright to the inverted position or vice-versa, and may select the amount of inversion angle. In addition, in one or more embodiments the inversion table may automatically move the user between upright and inverted positions, possibly multiple times, using a programmable sequence of positions. This programmable control is described further below with respect to FIG. 6.

FIG. 4 shows potential degrees of freedom for illustrative therapy elements of inversion table 100. Controls and settings may be associated with any or all of these degrees of freedom. For example, right and left back massage elements may move along the superior-inferior axis in directions 402a and 402b (up and down within their associated tracks); they may rotate or twist back and forth along rotation paths 403a and 403b, and they may vibrate in modes 404a and 404b. The position, speed, and intensity of any of these motions may be controllable or programmable. Similar degrees of freedom may be available for right and left neck massage elements, such as up and down movements 407a and 407b, rotational movements 408a and 408b, and vibration modes 409a and 409b. The tilt angle 401 of the inversion table may be varied using manual or automatic control. Neck traction force 405 and leg traction force 406 may be controllable or programmable. An actuator may move the position of knee rest 115 up or down along path 411. For embodiments equipped with one or more heating pads, the temperature or heat output 410 may be controllable or programmable. Similar degrees of freedom may be available for the massage elements 211a, 211b, 222a, and 222b of embodiment 100a shown in FIG. 2A.

In one or more embodiments, the inversion table may include or communicate with one or more processors that control the actuators to achieve the desired settings or sequences of settings for the degrees of freedom of the inversion table. For example, a microprocessor 420 may be integrated into the inversion table and connected electrically or wirelessly to the actuators. One or more embodiments may use any type or types of processors for control, including for example, without limitation, a microprocessor, a microcontroller, a customized circuit, an ASIC, a CPU, a GPU, a laptop or desktop or tablet computer, a server, a mobile device, a smart phone, a smart watch, or a network of any of these devices.

In one or more embodiments, the user of the inversion table, or a therapist or assistant, may be able to control some or all of the settings associated with these degrees of freedom. For example, the inversion table may include a controller 120 with buttons or switches to select or modify settings; this controller may communicate with processor 420. In one or more embodiments, a user may use an external device such as a smartphone 421 that executes an application that presents controls to the user, and this device may for example communicate over a wireless channel 422 with processor 420. Any types of controls may be presented to the user; for example, a user may use top-level controls such as buttons 423a through 423d to bring up submenus or detail screens for control of individual therapy elements. In one or more embodiments a control device (such as controller 120 or smartphone 421) may include a microphone, or may communicate with another device (such as a smart speaker) with a microphone, and a user or therapist may be able to control the inversion table operation using audio commands. In manual mode (when the inversion table is not executing a pre-programmed sequence of operations), the user or therapist may use any input device to manually control any of the machine's features. For example: (1) Inversion control mode: while in the negative phase, the user may use an input device to modify the device tilt down from 0 degrees to minus 50 degrees and in positive mode up to from minus 50 degrees to 0 degrees and then down from 0 degrees to plus 50 degrees or to any desired position or range. (2) Percussion (massage) control: the user may use an input device to turn on the feet-massager from level 1-5 as desired, or the calves-massager from level 1-5 as desired or hamstrings-massager from level 1-5 as desired or the gluteal-massager from level 1-5 as desired or back-massager from level 1-5 as desired or the neck-massager from level 1-5 as desired, or all five features including the feet, the calves, the hamstrings, the glutes, the back and the neck massage units simultaneously at various levels as desired. (3) Traction control: the user may use an input device to activate the lumbar/lower back traction unit to the desired tension or use the thoracic/back traction unit to the desired tension or use the cervical/neck traction unit to the desired tension or use the shoulder traction unit to the desired tension. (4) Heat control: the user may use an input device to activate the heating pads at various temperatures on the feet, calves, hamstrings, gluteal muscles, back, and neck assemblies. (5) Infrared light control: the user may use an input device to activate the light panels at various temperatures and to move the light panels to desired distances from the user's arms, legs, shoulders, face and torso.

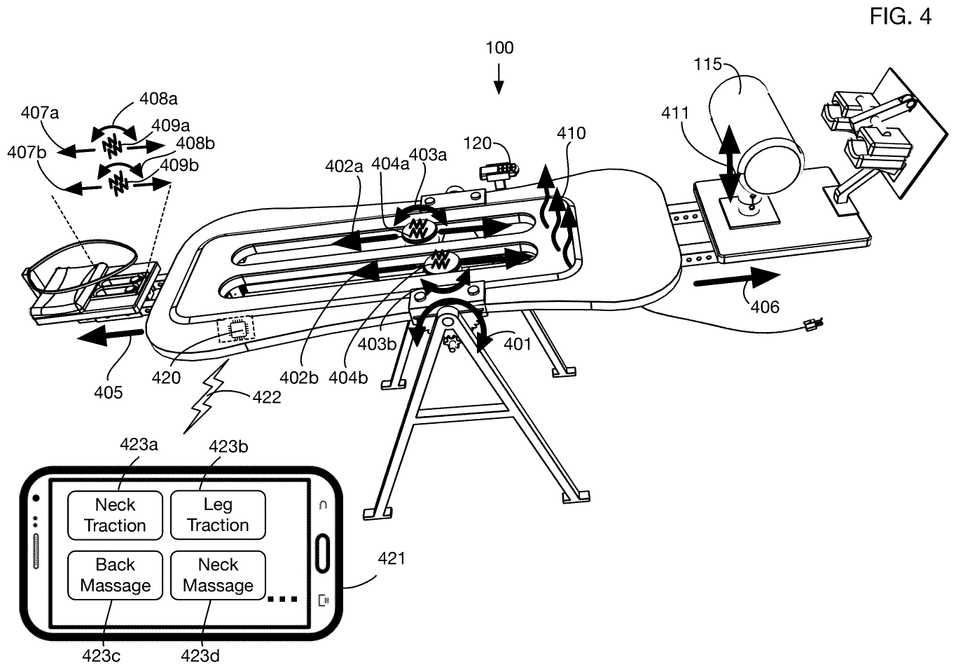

Embodiments may use any type or types of actuators to achieve the desired output and settings of the therapy elements. FIG. 5 shows for example illustrative actuators to position back massage elements 112a and 112b along their associated tracks, and to modify the tilt angle of the inversion table. In this embodiment, massage elements 112a and 112b are coupled to belts 501a and 501b, respectively, and motors may for example be housed near pulleys or sprockets 511a and 511b to drive the belts. A motor 502 may be coupled to a gear 503 to modify the tilt angle of the inversion table. Similar actuators may be used for other elements such as traction forces and neck massage elements.

In one or more embodiments, the inversion table may include one or more stored programs that cycle the therapy elements through sequences of settings. Programs may for example be selectable or customizable by a user or therapist. One or more embodiments may expose an application programming interface that allows for additional programs to be developed or modified. FIG. 6 shows an illustrative sequence of settings that may for example be generated by a stored program that executes on the processor of the inversion table. Settings for one or more of the actuators may be modified over time, possibly in repeating patterns at any desired frequencies. Illustrative settings 601 over time 602 are shown for the up-down positions 603 and 604 of left and right back massagers, for the neck traction force 605, and for the temperature 606 of the back heating pad. Similar settings patterns may be applied to any of the inversion table's therapy elements. Patterns of any frequency and shape may be applied to any or all of the elements. In one or more embodiments, random variations in some or all of these patterns may also be applied via the stored programs, which may improve therapeutic effect in some situations.

Another illustrative program may for example modify the pitch angle of the inversion table over time. For example, one such program may set the pitch angle to −25 degrees for 70 seconds, then set the pitch angle to −35 degrees for 60 seconds, then set the pitch angle to −45 degrees for 50 seconds, then set the pitch angle to −55 degrees for 40 seconds, and then set the pitch angle to −65 degrees for 30 seconds. This program is illustrative; one or more embodiments may modify pitch angle or any other settings over time using any desired patterns.

Illustrative ranges or levels for settings of various elements of an illustrative embodiment of the invention are shown in the tables below. These values are illustrative and embodiments may modify or extend these levels and ranges as desired or required.

### Head and Neck Assembly: Ranges or Levels

| Assembly Adjustment Range | 5-15 | inches |
|---|---|---|
| Cervical Traction Tension Levels | 1-5 | levels |
| Percussion Pad Contact Pressure | Soft, Medium, Hard | |
| Percussion Pad Horizontal Travel Speeds | 1-3 | inches/sec |
| Percussion Speed Frequency (pulses/sec) | 30, 60, 120, 240, 480 | |
| Bi-Lateral Percussion Pad Travel Range | 1-5 | inches |

### Body and Center Assembly: Ranges or Levels

| Inversion Pitch Angle range | +50 to −65 | degrees |
|---|---|---|
| Percussion Pad Contact Pressure | Soft, Medium, Hard | |
| Percussion Speed Frequency (pulses/sec) | 30, 60, 120, 240, 480 | |
| Bi-Lateral Percussion Pad Travel Range | 0-26 | inches |
| Uni-Lateral Percussion Pad Travel Range | + or −13 | inches |
| Percussion Pad Horizontal Travel Speeds | 3-6 | inches/sec |
| Single Side (Let or Right Percussion Pad) | 0-26 | inches |
| Adjustable Heating Pad (75-110 degree temp) | 1-3 | levels |

### Foot and Leg Assembly: Ranges or Levels

| | |
|---|---|
| Assembly Traction Travel Range (horizontal) | 0-30 inches |
| Telescopic Knee Range (vertical adjustment) | 0-14 inches |

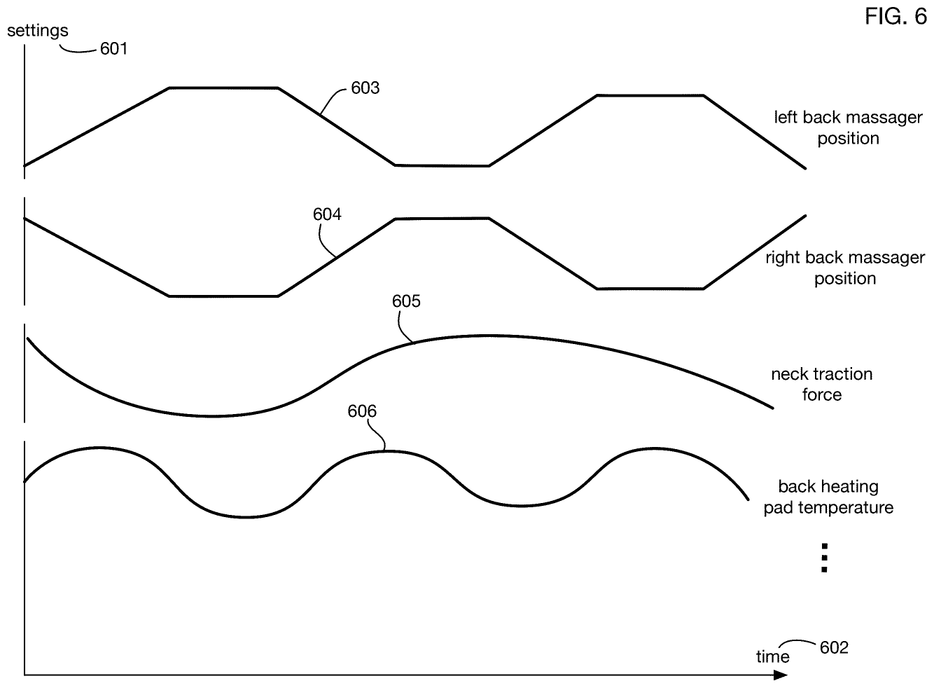

FIG. 7 shows a block diagram of an illustrative embodiment 100b of the invention. This embodiment has a back rest and also has supports for neck and head, and for legs and feet. It includes several types of therapy actuators. Settings for each actuator may be independently controlled. Tilt angle actuator 701 controls the angle of the table, supporting both inversion (head below feet, with a negative tilt angle) and upwards tilt (head above feet, with a positive tilt angle). It has two (or more) traction actuators, including lumbar traction actuator 702a, and thoracic traction actuator 702b; the tension and direction of these actuators may be controlled. It has six massage elements: feet massage element 703a, calves massage element 703b, hamstrings massage element 703c, gluteal muscles massage element 703d, back massage element 703e, and neck massage element 703f. Massage elements may slide, vibrate, or move in any degree or degrees of freedom. It has five (or more) heating pads with controllable temperatures: feet heating pad 704a, calves heating pad 704b, hamstrings heating pad 704c, gluteal muscles heating pad 704d, and back heating pad 704e. It has one or more infrared heating panels 705; these panels may be moveable to direct infrared heat to any part of the user's body, and their temperature may be adjusted. These actuators are illustrative; one or more embodiments may have any subset of these actuators and may have additional types or numbers of actuators of any type.

The multi-therapy table may have a processor 420 that is connected to each of the actuators. The processor may activate or deactivate and modify the settings of each actuator independently. An input control device such as a phone 421, or a dedicated touchscreen or other device coupled to the table, may receive commands from the table user (or from a practitioner or other user), and may transmit these commands to processor 420 to modify the actuator settings. In one or more embodiments, control device 421 may have a microphone and may accept and interpret audio (voice) commands, such as commands 710 and 711, or it may receive voice commands from an external device such as a smart speaker. The user or operator may control actuator activation and settings either manually (specifying settings for each actuator, as in command 710) or by initiating one or more stored programs that may be stored for example either on device 421 or on a memory coupled to processor 420, as in command 711. In manual mode, illustrative commands provided by a user may include for example: Set tilt angle in inversion mode from 0 degrees to minus 50 degrees and in positive mode up to from minus 50 degrees to 0 degrees and then down from 0 degrees to plus 50 degrees to a desired position or range. Turn on the foot-massager from level 1-5 as desired, or the calf-massager from level 1-5 as desired or hamstring-massager from level 1-5 as desired or the gluteal-massager from level 1-5 as desired or back-massager from level 1-5 as desired or the neck-massager from level 1-5 as desired or activate all massage elements simultaneously at various levels as desired. Activate the lumbar/lower back traction unit to the desired tension or use the thoracic/back traction unit to the desired tension or use the cervical/neck traction unit to the desired tension or use the shoulder traction unit to the desired tension. Activate the heating pads at various temperatures on the foot, calf, hamstring, gluteal and neck assemblies. Activate the infrared light panels, move them to desired distances to and from the user's arms, legs, shoulders, face and torso, and set temperatures to the desired levels. These commands are illustrative; users may manually control any setting of any actuator or any combination of actuators.

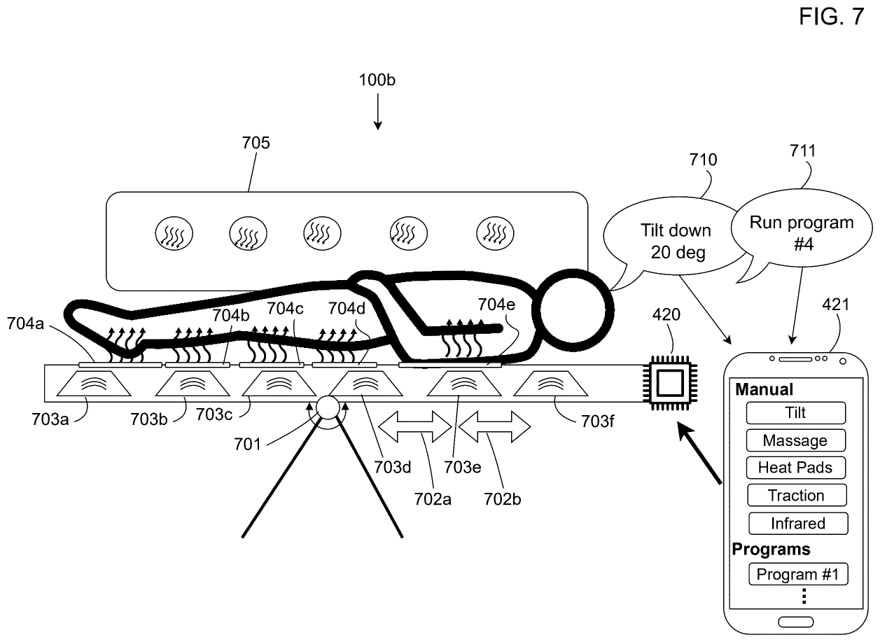

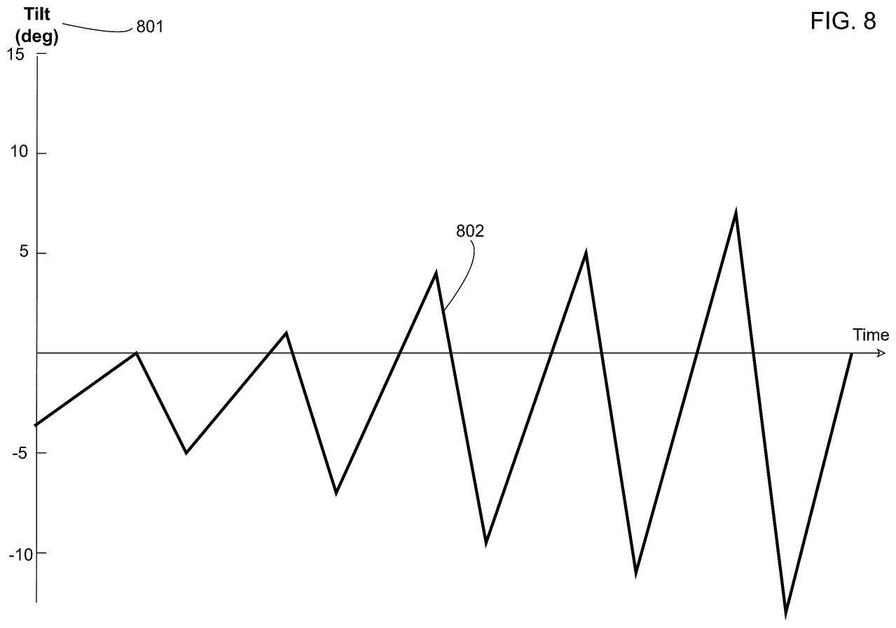

A user or operator may also issue commands to initiate any stored program, which may modify the settings of any of the actuators in a predefined sequence or pattern. FIGS. 8 through 12 describe five illustrative programs that may be used in one or more embodiments. These are illustrative programs; any modifications, additions, or combinations of any of these actions may be included in programs in one or more embodiments of the invention.

FIG. 8 illustrates a program that performs dynamic inversion by changing the tilt 801 of the table through a sequence of angle ranges 802. In this example, the width of the angle ranges increases as the program progresses: the upper limit (positive tilt) gets larger, and the lower limit (negative tilt) gets smaller. Specific values illustrated in curve 802 are: tilt begins at −3 degrees negative and moves to +0 degrees positive, then tilt moves from −5 degrees negative to +1 degree positive, then tilt moves from −7 degrees negative to +3 degrees positive, next tilt moves from −9 degrees negative to +5 degrees positive, then tilt moves from −11 degrees negative to +7 degrees positive, and lastly tilt moves from −13 degrees back to +0 degrees.

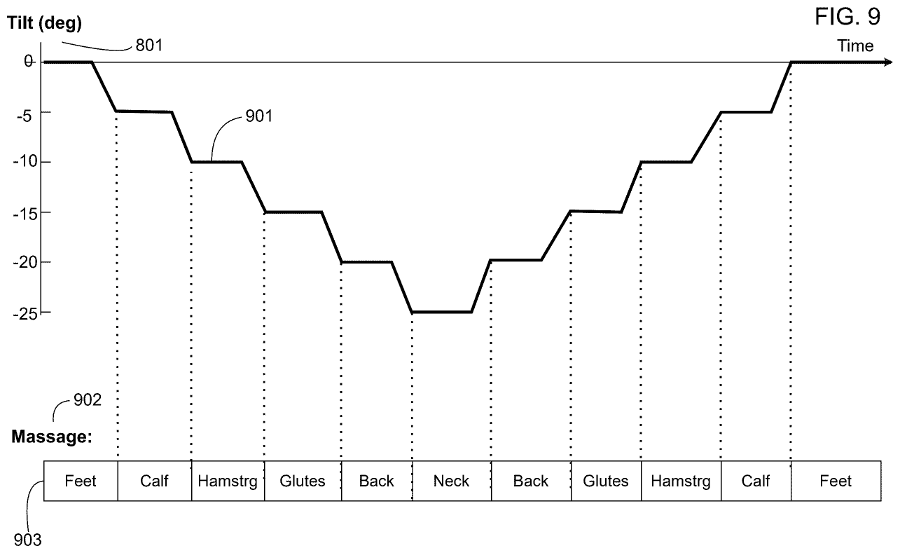

FIG. 9 illustrates a program that performs dynamic massage 902 in combination with dynamic inversion. The tilt 801 of the table moves through a sequence of angles 901, and at each angle change, a different massage element 903 is activated. In this example, the tilt angles become successively more negative (greater inversion) and then reverse and return to level. The specific settings illustrated in this example are: tilt begins at −0 degrees negative and the feet massage element is activated (starts to move from toes to heels), next the tilt moves down to −5 degrees negative and the calves massage element is activated (starts to move from heels to knees), then the tilt moves down to −10 degrees negative and the hamstrings massage element is activated (starts to move from knees to glutes), then the tilt moves down to −15 degrees negative and the gluteal muscle massage element is activated (moves from gluteal muscles to back), then the tilt moves down to −20 degrees negative and the back massage element is activated (moves from back to neck), and then the tilt moves to −25 degrees negative and the neck massage element is activated. The sequence then reverses as the tilt goes back towards 0 and the order of activation of the massage elements is reversed.

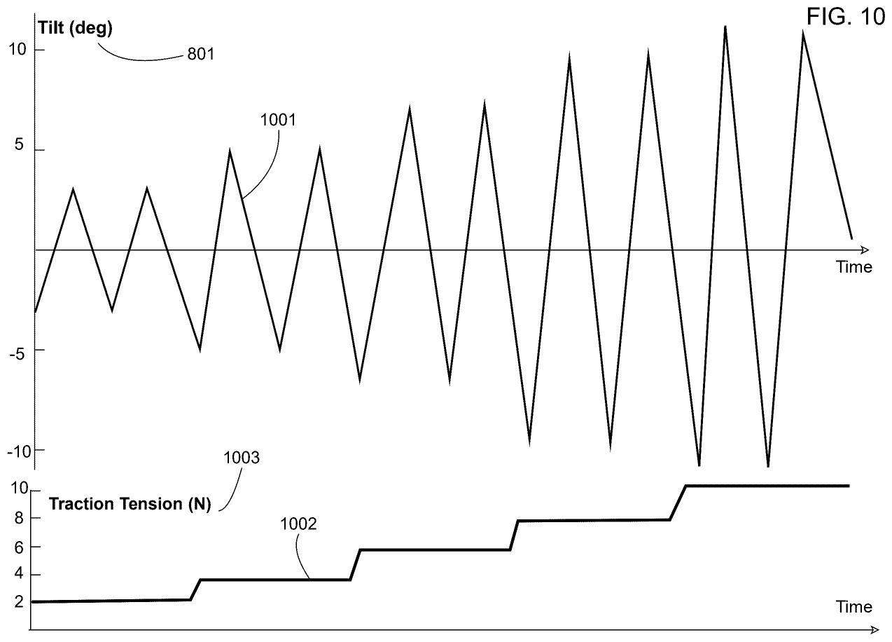

FIG. 10 illustrates a program that performs dynamic traction in combination with dynamic inversion. The tilt 801 of the table moves through a sequence of angle ranges 1001, and at each increase in angle range width, the traction tension 1003 of the thoracic and lumbar traction elements is increased in sequence 1002. Lumbar and thoracic traction may pull in opposite directions. The angle range sequence 1001 increases the width of the angle range over time, with increasing maximums and decreasing minimums. In this example each move from the lower to the upper bound of the angle range is performed twice before moving to the next wider angle range. The specific values illustrated in this example are: first the tilt angle range is set from −3 degrees to +3 degrees and the traction tension is set to 2 Newtons, then the tilt angle range is set from −5 degrees to +5 degrees and the traction tension is set to 4 Newtons, then the tilt angle range is set from −7 degrees to +7 degrees and the traction tension is set to 6 Newtons, then the tilt angle range is set from −9 degrees to +9 degrees and the traction tension is set to 8 Newtons, and then the tilt angle range is set from −11 degrees to +11 degrees and the traction tension is set to 10 Newtons.

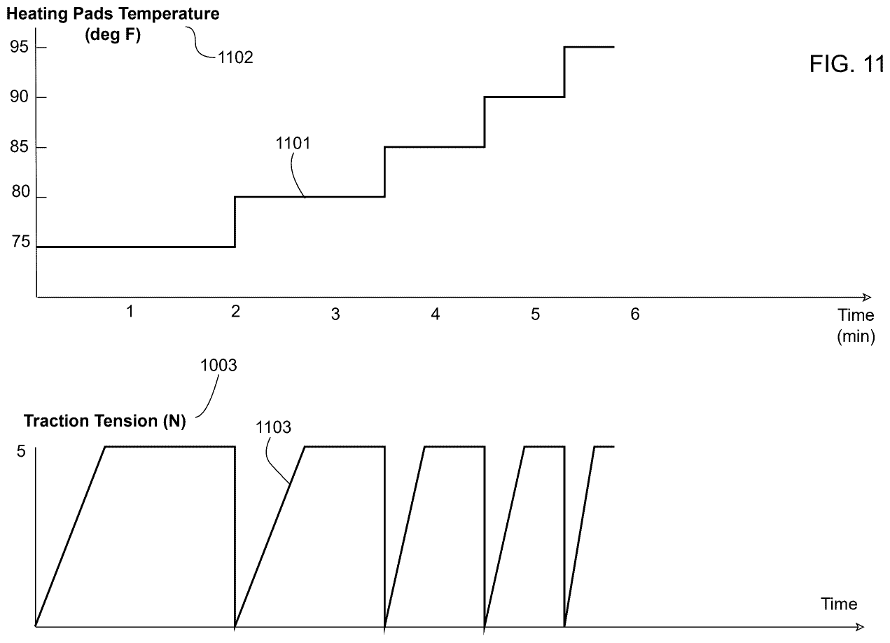

FIG. 11 illustrates a program that performs dynamic heating in combination with dynamic traction. The temperature 1102 of one or more of the heating pads is increased in a sequence 1101 of temperatures; at each higher temperature, the duration of time at that temperature is reduced. Traction tension 1003 is cycled in curve 1103 during each temperature step. The specific values illustrated in this example are: first temperature is set to 75 degrees F. for 120 seconds, and traction is cycled from 0 Newtons to 5 Newtons, then temperature is set to 80 degrees F. for 90 seconds, and traction is cycled from 0 Newtons to 5 Newtons, then temperature is set to 85 degrees F. for 60 seconds, and traction is cycled from 0 Newtons to 5 Newtons, then temperature is set to 90 degrees F. for 45 seconds, and traction is cycled from 0 Newtons to 5 Newtons, then temperature is set to 95 degrees F. for 30 seconds, and traction is cycled from 0 Newtons to 5 Newtons.

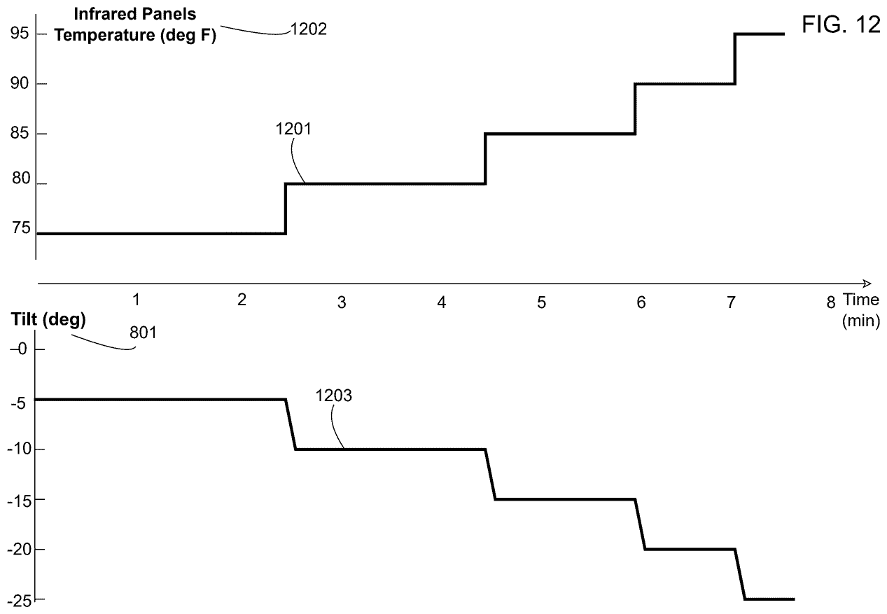

FIG. 12 illustrates a program that performs dynamic infrared heating in combination with dynamic inversion. The infrared heating panels are first moved into position, and then the temperature 1202 of one or more of the infrared heating panels is increased in a sequence 1201 of temperatures; at each higher temperature, the duration of time at that temperature is reduced. The tilt angle 801 is decreased (greater inversion) in a corresponding sequence 1203 of angles; as the temperature 1201 increases, the angle 1203 decreases (more inversion). The specific values illustrated in this example are: first the temperature is set to 75 degrees F. for 2.5 minutes at a tilt angle of −5 degrees, then the temperature is set to 80 degrees F. for 2 minutes at a tilt angle of −10 degrees, then the temperature is set to 85 degrees F. for 1.5 minutes at a tilt angle of −15 degrees, then the temperature is set to 90 degrees F. for 1 minute at a tilt angle of −20 degrees, and finally the temperature is set to 95 degrees F. for 0.5 minutes at a tilt angle of −25 degrees.

All of the specific setting values illustrated in FIGS. 8 through 12 and described above are illustrative; one or more embodiments of the invention may use programs with different specific values and with different combinations and sequences of actuator activation.

While the invention herein disclosed has been described by means of specific embodiments and applications thereof, numerous modifications and variations could be made thereto by those skilled in the art without departing from the scope of the invention set forth in the claims.

What is claimed is:

1. A programmable multi-therapy inversion table, comprising:
a supporting frame;
a back rest rotatably coupled to said supporting frame and configured to support a back of a user,
wherein said back rest comprises:
a superior end closest to a head of said user, and
an inferior end closest to feet of said user;
wherein said back rest is configured to rotate between
an upright position wherein said superior end is vertically higher than said inferior end, and
an inverted position wherein said superior end is vertically lower than said inferior end;
a leg and feet support coupled to said back rest;
a head and neck support coupled to said back rest;
a plurality of therapy actuators, comprising:
a table tilt actuator configured to rotate said back rest between said upright position and said inverted position;
a plurality of massage elements, each independently actuated, comprising:
a feet massage element;
a calves massage element;
a hamstrings massage element;
a gluteal muscles massage element;
a back massage element; and,
a neck massage element;
a plurality of traction elements, each independently actuated, comprising:
a thoracic traction element; and
a lumbar traction element;
a plurality of heating pads, each independently actuated, comprising:
a feet heating pad;
a calves heading pad;
a hamstrings heating pad;
a gluteal muscles heating pad; and
a back heating pad; and,
one or more infrared heating panels oriented to direct heat at a body of said user;
a processor coupled to said plurality of therapy actuators;
a memory coupled to said processor that contains one or more programs, wherein each program of said one or more programs is configured to modify one or more settings of one or more of said plurality of therapy actuators over time in a predefined sequence.

2. The programmable multi-therapy inversion table of claim 1, wherein:
a first program of said one or more programs is configured to modify a tilt angle of said table tilt actuator through a sequence of angle ranges;
each angle range of said sequence of angle ranges comprises a lower limit and an upper limit;
the lower limit of each angle range is lower than the lower limit of a previous angle range in said sequence of angle ranges; and,
the upper limit of each angle range is higher than the upper limit of the previous angle range in said sequence of angle ranges.

3. The programmable multi-therapy inversion table of claim 2, wherein said sequence of angle ranges comprises:
a first angle range from −3 degrees to +0 degrees;
a second angle range from −5 degrees to +1 degrees;
a third angle range from −7 degrees to +3 degrees;
a fourth angle range from −9 degrees to +5 degrees;
a fifth angle range from −11 degrees to +7 degrees;
and a sixth angle range from −13 degrees to 0 degrees.

4. The programmable multi-therapy inversion table of claim 1, wherein:
a second program of said one or more programs is configured to:
modify a tilt angle of said table tilt actuator through a sequence of angles; and,
activate a massage element of said plurality of massage elements at each angle of said sequence of angles.

5. The programmable multi-therapy inversion table of claim 4, wherein said second program is configured to perform a sequence of steps comprising:
set said tilt angle to 0 degrees and activate said feet massage element;
set said tilt angle to −5 degrees and activate said calves massage element;
set said tilt angle to −10 degrees and activate said hamstrings massage element;
set said tilt angle to −15 degrees and activate said gluteal muscles massage element;
set said tilt angle to −20 degrees and activate said back massage element; and,
set said tilt angle to −25 degrees and activate said neck massage element.

6. The programmable multi-therapy inversion table of claim 5, wherein said second program is further configured to perform said sequence of steps and then perform said sequence of steps in reverse order.

7. The programmable multi-therapy inversion table of claim 1, wherein:
a third program of said one or more programs is configured to:
modify a tilt angle of said table tilt actuator through a sequence of angle ranges; and,
set a tension of said thoracic traction element and of said lumbar traction element in opposite directions and equal magnitudes at each angle range of said sequence of angle ranges;
wherein:
a lower limit of each angle range is lower than the lower limit of a previous angle range in said sequence of angle ranges;
an upper limit of each angle range is higher than the upper limit of the previous angle range in said sequence of angle ranges; and,
said tension increases at each subsequent angle range of said sequence of angle ranges.

8. The programmable multi-therapy inversion table of claim 7, wherein:
said sequence of angle ranges and said tension comprise:
−3 degrees to +3 degrees, with said tension set to 2 Newtons;
−5 degrees to +5 degrees, with said tension set to 4 Newtons;
−7 degrees to +7 degrees, with said tension set to 6 Newtons;
−9 degrees to +9 degrees. with said tension set to 8 Newtons; and,
−11 degrees to +11 degrees, with said tension set to 10 Newtons.

9. The programmable multi-therapy inversion table of claim 8, wherein:
each angle range of said sequence of angle ranges is performed twice before moving to a subsequent angle range.

10. The programmable multi-therapy inversion table of claim 1, wherein:
a fourth program of said one or more programs is configured to:
set a temperature of one or more of said plurality of heating pads through a sequence of temperatures for a corresponding sequence of durations;
wherein:
said temperature increases through said sequence of temperatures; and,
duration decreases through said corresponding sequence of durations.

11. The programmable multi-therapy inversion table of claim 10, wherein said sequence of temperatures and said corresponding sequence of durations comprise:
75 degrees F. for 120 seconds;
80 degrees F. for 90 seconds;
85 degrees F. for 60 seconds;
90 degrees F. for 45 seconds; and,
95 degrees F. for 30 seconds.

12. The programmable multi-therapy inversion table of claim 11, wherein said fourth program is further configured to:
vary a tension of said thoracic traction element and of said lumbar traction element from 0 Newtons to 5 Newtons at each temperature of said sequence of temperatures.

13. The programmable multi-therapy inversion table of claim 1, wherein:
a fifth program of said one or more programs is configured to:
set a temperature of said one or more infrared heating panels through a sequence of temperatures for a corresponding sequence of durations; and,
set a tilt angle of said table tilt actuator through a corresponding sequence of angles;
wherein:
said temperature increases through said sequence of temperatures;
duration decreases through said corresponding sequence of durations; and,
said tilt angle decreases through said corresponding sequence of angles.

14. The programmable multi-therapy inversion table of claim 13, wherein said sequence of temperatures, said corresponding sequence of durations, and said corresponding sequence of angles comprise:
75 degrees F. for 2.5 minutes at −5 degrees tilt;
80 degrees F. for 2 minutes at −10 degrees tilt;
85 degrees F. for 1.5 minutes at −15 degrees tilt;
90 degrees F. for 1 minute at −20 degrees tilt;
95 degrees F. for 0.5 minutes at −25 degrees tilt.

15. The programmable multi-therapy inversion table of cl claim 1, further comprising:
a control device configured to receive commands to change settings of one or more of said plurality of therapy actuators, and to transmit said commands to said processor.

16. The programmable multi-therapy inversion table of claim 15, wherein said control device is further configured to receive said commands via audio.
